(19) United States
(12) Patent Application Publication
(10) Pub. No.: US 2013/0142947 A1
(43) Pub. Date: Jun. 6, 2013

(54) Method and Device for Manufacturing Color Filter

(71) Applicant: Jo shan Wu, Shenzhen (CN)

(72) Inventor: Jo shan Wu, Shenzhen (CN)

(21) Appl. No.: 13/378,121

(22) PCT Filed: Dec. 6, 2011
(86) PCT No.: PCT/CN11/83586

§ 371 Date: Dec. 14, 2011

(30) Foreign Application Priority Data
Dec. 2, 2011 (CN) 2011103959948

(51) Int. Cl. B05D 5/06; B05C 1/00

(52) U.S. Cl. 427/162; 118/200

(57) ABSTRACT

The present invention discloses method and device for manufacturing color filter, comprising the following steps: apply color filter materials to a roller at certain intervals; press the roller on a half-tone screen provided with preset patterns to form color filter patterns; transfer printing of the color filter patterns to a glass substrate by the roller to form a color filter. Compared with the prior art, the present invention has the advantages that the method is simple, the traditional exposure method is replaced by the pressing method, the photolithographic process is not required in the process of manufacturing the color filter, a mask and chemical liquids required by other photolithographic processes are not used, the cost for mechanical equipment and materials and the manufacturing cost are reduced greatly, and in addition, the material cost is reduced because the photolithographic process is not required in the process of manufacturing the color filter, filter materials can be replaced by other substitute materials, and photoresist is not used.

### TECHNICAL FIELD

The present invention relates to method for manufacturing liquid crystal panel, in particular to method and device for manufacturing color filter.

BACKGROUND

The liquid crystal panel is one of critical components of liquid crystal electronic equipment; the liquid crystal panel, particularly TFT (Thin Film Transistor) LCD (Liquid crystal display) has the advantages of better combined performance in luminance, contrast, power consumption, life, volume, weight, etc. than that of a CRT (cathode ray tube) display, good performance and large-scale production characteristic, high degree of automation, and low material cost; the liquid crystal panel rapidly become a main product in new century and is most readily accepted by the market of liquid crystal panels. One of the most expensive components of TFT LCD is the color filter.

FIG. 1 is the sectional diagram of the existing color filter. Color filter materials including parallel red block 102, green block 103, and blue block 104 as shown in Figure are deposited on a glass substrate 101. A black matrix 105 is arranged among the blocks. One layer of coating 106 is applied to the blocks 102, 103, and 104, and the black matrix 105; the coating 106 is provided with a transparent electrode 107 of an indium-tin oxide. When the color filter is manufactured, firstly, one layer of black photosensitive resin is applied to the glass substrate 101; secondly, multiple equally spaced black matrixes 105 are formed by using the manufacturing processes such as exposure, development, baking, etc.; thirdly, the color filter is manufactured by using the above masking processes; then, the coating 106 is applied to the glass substrate 101; finally, the transparent electrode 107 of the indium-tin oxide is deposited on the coating 106.

In the manufacturing method, the processes of exposure, development, baking, etc. are used; multiple chemical liquids such as photoresist and developer, and expensive mechanical equipment are required during manufacturing; the mask is a necessary tool for manufacturing the filter; the mask made of quartz is very expensive; the larger the TFT LCD panel is, the larger the glass substrate of the filter is; therefore, the used mask is larger and more expensive. Additionally, it is difficult to repair the damaged quartz mask; the damaged mask cannot make light transmit uniformly; a defect can be caused to each color filter. The manufacturing method has the disadvantages of complex process and high cost.

### SUMMARY

The aim of the present invention is to provide a method and device for manufacturing a color filter with a simple process and low cost.

The purpose of the present invention is achieved by the following technical schemes: a method for manufacturing a color filter, comprising the following steps: apply color filter materials to a roller at certain intervals; press the roller on a half-tone screen provided with preset patterns to form color filter patterns; transfer printing of the color filter patterns to a glass substrate by the roller to form a color filter.

Wherein, the color filter materials include the red filter material, the green filter material, and the blue filter material. Red, green, and blue can be mixed to form multiple colors.

Wherein, the red filter material, the green filter material, and the blue filter material are respectively applied on the roller around the circumference at equal intervals to form multiple color bands on the roller to correspond to the related position.

Wherein, the half-tone screen is provided with patterns at preset intervals; the patterns are arranged in the form of a matrix or multiple lines at equal intervals. The matrix properly corresponds to the related position on the filter; the filter materials on the roller are arranged at certain intervals; only multiple lines of patterns are required.

Wherein, the patterns are stickum applied to the half-tone screen; the stickum can bond the filter materials. The banded filter materials on the roller are divided into the required matrix by using the stickum; the way is quick and has better effect; i. e. deviation of the filter materials cannot be caused.

Wherein, the patterns are multiple grooves formed on the half-tone screen; sticky materials are not used on the grooved half-tone screen.

Wherein, the grooves are formed from resin materials deposited on the half-tone screen; the resin materials can form the patterns on the half-tone screen conveniently.

Wherein, the filter materials are photoresist. Because photolithography is not used to form a color filter in the method, the filter materials can be replaced by other materials. However, photoresist is an optional material.

Wherein, the method for manufacturing a color filter further includes the formation of a black matrix on the glass substrate. The black matrix is used to form intervals so as to ensure the display quality.

Wherein, the method for manufacturing a color filter further includes the deposition of a transparent electrode of an indium-tin oxide on the coating.

A device for manufacturing a color filter, comprising: a roller, a coating machine used for applying color filter materials to the roller at certain intervals, and a half-tone screen provided with preset patterns to press the roller to form color filter patterns; the roller is used for transferring printing of the color filter patterns to the glass substrate to form a color filter.

Compared with the prior art, the present invention has the advantages that the method is simple, and the traditional exposure method is replaced by the pressing method. Firstly, the filter materials are applied to the roller at certain intervals; then the roller is pressed on the half-tone screen provided with preset patterns to form color filter patterns, i. e. multiple filter blocks arranged in the form of a matrix; finally, the roller transfers printing of the color filter patterns to the glass substrate to form the color filter. That is to say, the photolithographic process is not required in the process of manufacturing the color filter; the mask and chemical liquids required by other photolithographic processes are not used; the cost for mechanical equipment and materials and the manufacturing cost are reduced greatly; in addition, the material cost is reduced because the photolithographic process is not required in the process of manufacturing the color filter, the filter materials can be replaced by other substitute materials, and photoresist is not used.

### DESCRIPTION OF FIGURES

FIG. 1 is a structural sectional view of the existing color filter;

FIG. 2 is the structural diagram of the first step of the method for manufacturing the color filter of the embodiment of the present invention;

FIG. 3 is the structural diagram of the second step of the method for manufacturing the color filter of the embodiment of the present invention;

FIG. 4 is the structural diagram of the third step of the method for manufacturing the color filter of the embodiment of the present invention.

### DETAILED DESCRIPTION

The present invention is further described by figures and the preferred embodiments as follows.

The method for manufacturing the color filter of the embodiment of the present invention includes the following steps: firstly, apply the color filter materials to the roller; secondly, press the roller on the half-tone screen to form patterns arranged in the form of a matrix on the surface of the roller; thirdly, transfer printing of the patterns arranged in the form of a matrix to the glass substrate by the roller. The device for manufacturing a color filter used in the method comprises a roller, a coating machine used for applying color filter materials to the roller at certain intervals, and a half-tone screen provided with preset patterns to press the roller to form color filter patterns; the roller is used for transferring printing of the color filter patterns to the glass substrate to form a color filter.

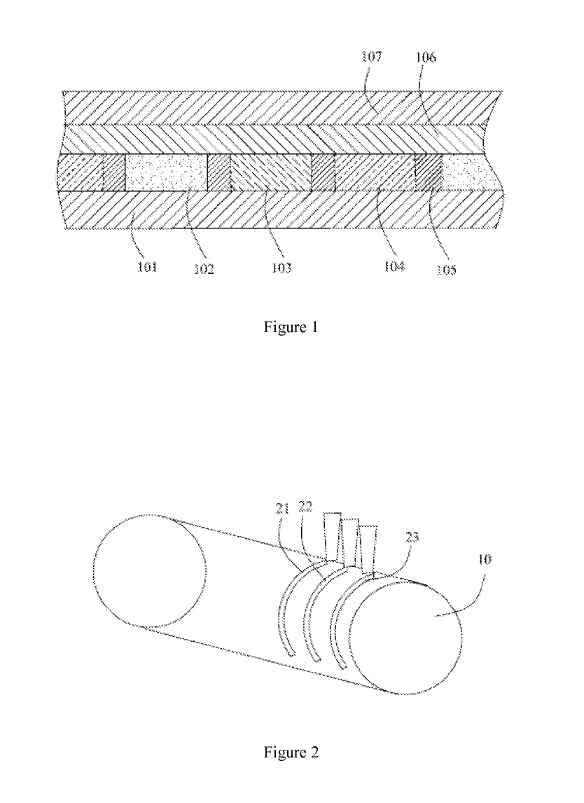

Refer to FIG. 2. In the first step, the color filter materials include a red filter material 21, a green filter material 22 and a blue filter material 23; the three filter materials 21, 22, and 23 are respectively applied on the roller 10 around the circumference at equal intervals to form multiple color filter bands on the roller 10.

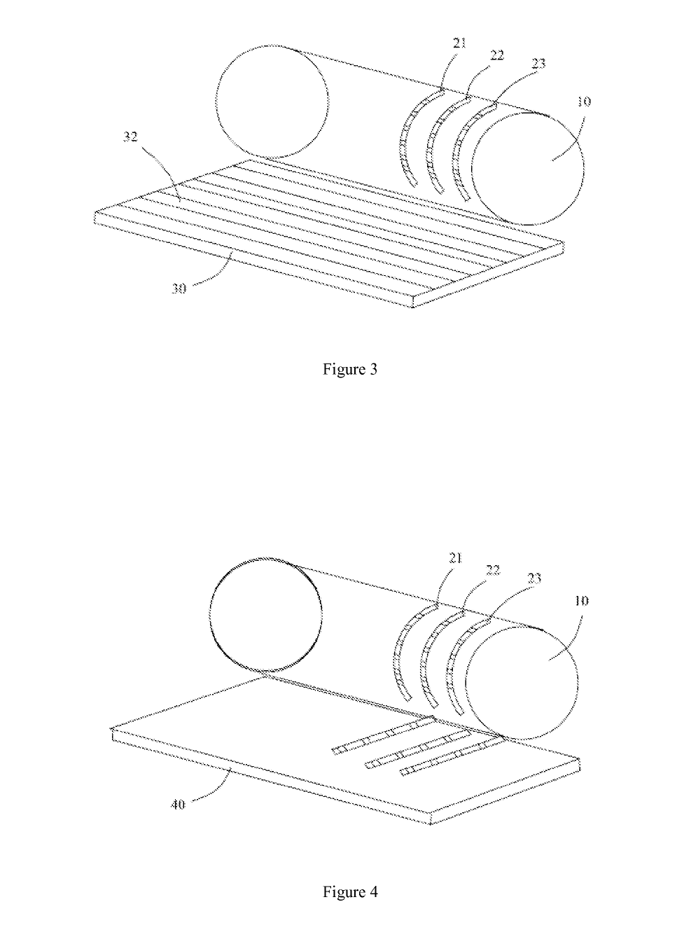

Refer to FIG. 3. In the second step, a half-tone screen 30 is provided; patterns 32 are formed on the half-tone screen 30; the patterns 32 can be formed from black photoresist or other resin materials. The patterns 32 can be in the form of a matrix or other parallel bands. In this embodiment, the half-tone screen 30 is provided with multiple parallel equally spaced patterns 32. The roller 10 applied with the filter materials 21, 22, and 23 is pressed on the half-tone screen 30; the banded filter materials 21, 22, and 23 on the roller and the patterns 32 are crossed; after the roller 10 is pressed on the half-tone screen, the filter materials on the roller 10 are divided into a matrix arranged on the surface of the roller by the patterns 32 on the half-tone screen.

Refer to FIG. 4. In the third step, a glass substrate 40 is provided; the roller 10 provided with the filter materials arranged in the form of a matrix is pressed on the glass substrate 40; the printing of the filter materials arranged in the form of a matrix is transferred to the glass substrate 40.

The method for manufacturing the color filter further includes the application of other coatings such as insulating coating, etc. to the glass substrate 40; the coating covers the color filter and the black matrix.

The method for manufacturing the color filter further includes the deposition of the transparent electrode of the indium-tin oxide on the insulating coating; then the color filter is manufactured.

It is generally understood that the patterns on the half-tone screen 30 can be formed from multiple lines of equally spaced stickum applied to the half-tone screen 30; the shape of the stickum corresponds to the shape required by the color filter materials 21, 22, and 23 as shown in FIG. 1, so that the corresponding parts of the filter materials 21, 22, and 23 are adsorbed after the roller 10 is pressed on the half-tone screen 30 and the required matrix is formed correspondingly on the roller 10.

Or, the patterns can be multiple grooves formed on the half-tone screen; the filter materials of the pressed roller can be divided into a matrix by the grooves.

In addition, because the photolithography is not used to form the color filter in the present invention, traditional photoresist is not used for the color filter materials. However, in the existing materials, the photoresist can also be selected as a material for manufacturing the color filter.

The method for manufacturing a color filter is simple; the traditional exposure method is replaced by the pressing method; the mask is not used; the cost for mechanical equipment and materials and the manufacturing cost are reduced greatly.

The present invention is described in detail in accordance with the above contents with the specific preferred embodiments. However, this invention is not limited to the specific embodiments. For the ordinary technical personnel in the technical field of the present invention, on the premise of keeping the conception of the present invention, the technical personnel can also make simple deductions or replacements, and all of which should be considered to belong to the protection scope of the present invention.

We claim:

1. A method for manufacturing color filter, comprising the following steps: apply color filter materials to a roller at certain intervals; press the roller on a half-tone screen provided with preset patterns to form color filter patterns; transfer printing of the color filter patterns to a glass substrate by the roller to form a color filter.

2. The method for manufacturing color filter of claim 1, wherein said color filter materials include a red filter material, a green filter material, and a blue filter material.

3. The method for manufacturing color filter of claim 2, wherein said red filter material, green filter material, and blue filter material are respectively applied on the roller around the circumference at equal intervals.

4. The method for manufacturing color filter of claim 1, wherein said half-tone screen has patterns at preset intervals; the patterns are arranged in the form of a matrix or multiple lines at equal intervals.

5. The method for manufacturing color filter of claim 4, wherein said patterns are stickum applied to the half-tone screen; the stickum can bond the filter materials.

6. The method for manufacturing color filter of claim 4, wherein said patterns are multiple grooves formed on the half-tone screen.

7. The method for manufacturing color filter of claim 6, wherein said grooves are formed from resin materials deposited on the half-tone screen.

8. The method for manufacturing color filter of claim 1, wherein said filter materials are photoresist.

9. The method for manufacturing color filter of claim 1, wherein said method further includes the formation of a black matrix on the glass substrate.

10. The method for manufacturing color filter of claim 9, wherein said method further includes the deposition of a transparent electrode of an indium-tin oxide on the coating.

11. Device for manufacturing a color filter, comprising: a roller, a coating machine used for applying color filter materials to the roller at certain intervals, and a half-tone screen provided with preset patterns to press the roller to form color filter patterns; said roller is used for transferring printing of the color filter patterns to the glass substrate to form a color filter.
